(19) United States
(12) Patent Application Publication
(10) Pub. No.: US 2016/0072601 A1
(43) Pub. Date: Mar. 10, 2016

(54) Enhanced Communication Link Using Synchronization Signal as Link Command

(71) Applicant: Silicon Image, Inc., Sunnyvale, CA (US)

(72) Inventors: Shrikant Ranade, Campbell, CA (US); Qian Yao, Cupertino, CA (US); Lei Ming, San Jose, CA (US); Young IL Kim, Sunnyvale, CA (US); Jiong Huang, Sunnyvale, CA (US); Hoon Choi, Mountain View, CA (US)

(21) Appl. No.: 14/483,013

(22) Filed: Sep. 10, 2014

(51) Int. Cl. H04J 3/06; H04J 3/16; H04L 5/14

(52) U.S. Cl. CPC H04J 3/0602; H04L 5/14; H04J 3/1694

(57) ABSTRACT

A system communicating over a full duplex control channel of a multimedia communication link by using synchronization signals that may also function as a logical link command. Synchronization indicators are exchanged between two communicating devices for maintaining synchronization of a logical link. At least two different types of synchronization signals may be sent between the two devices as synchronization indicators. A first synchronization signal is used by default to maintain synchronization of a logical link. A second synchronization signal is used in place of the first synchronization signal to maintain synchronization of the logical link. The second synchronization signal may be used to imply a virtual link command to indicate that a device is ready to receive data or has successfully received data over the virtual link.

### BACKGROUND

1. Field of the Disclosure

This disclosure pertains in general to data communications, and more specifically to channel synchronization maintenance in a multimedia communication link.

2. Description of the Related Art

Devices that communicate over a control channel of a multimedia communication link (e.g., Mobile High Definition Link (MHL)) have traditionally been using speculative transfer protocol. In such speculative transfer protocol, small fixed-length packets are exchanged. A device may send packets speculatively, assuming that the other device has sufficient room for the data in its buffer. For this reason, a data packet may need to be sent multiple times and data transfer may be delayed as the data packet may be sent when the other device does not have sufficient capacity to receive or process the data packet. As a result, latency of this communication may be high and may cause data transfer between devices to be slow.

### SUMMARY

Embodiments of the present disclosure are related to an apparatus for communicating audiovisual data with another devise. The apparatus includes a receiving module and a sending module. The receiving module receives a request from the other apparatus to transmit a payload to the apparatus over a full duplex data link. The sending module sends data to the second apparatus. The data includes a series of synchronization indicators for maintaining synchronization of the full duplex data link with the other apparatus over the full duplex data link. The sending module also sends a first predetermined signal as one of the series of synchronization indicators to the other apparatus to cause the other apparatus to send the payload to the first apparatus over the full duplex data link when it is determined that the first apparatus is ready to receive the payload from the second apparatus.

In one embodiment, the sending module sends a second predetermined signal as one of the series of synchronization indicators to indicate maintaining of synchronization of the full duplex data link without indicating that the first apparatus is ready to receive the payload from the other apparatus.

In one embodiment, the sending module sends the first pre-determined signal as one of the series synchronization indicators to the other apparatus to acknowledge to the other apparatus receipt of the payload by the first apparatus over the full duplex data link when it is determined that the apparatus received the payload from the other apparatus.

In one embodiment, the series of synchronization indicators is sent periodically in a Time-Division Multiplexing (TDM) time slot.

Embodiments also relate to an apparatus with a sending module that sends a request to transmit a payload to another apparatus over the full duplex data link, and send the payload to the other apparatus over the full duplex data link when a first predetermined signal in a series of synchronization indicators is received at a receiving module of the apparatus. The first predetermined signal indicates that the second apparatus is ready to receive the payload. The data that the receiving module receives includes the series of synchronization indicators for maintaining synchronization of a full duplex data link with the other apparatus over the full duplex data link.

### BRIEF DESCRIPTION OF THE DRAWINGS

The teachings of the embodiments disclosed herein can be readily understood by considering the following detailed description in conjunction with the accompanying drawings.

FIG. 1 is a high-level block diagram of a system for data communications, according to one embodiment.

FIG. 2 is a diagram illustrating synchronization characters sent in allocated time-division multiplexed (TDM) time slots to establish or maintain a logical link in the multimedia system of FIG. 1, according to an embodiment.

FIG. 3 is a diagram illustrating a synchronization training sequence for establishing or maintaining a logical link in the multimedia system of FIG. 1, according to an embodiment.

### DETAILED DESCRIPTION

The Figures (FIG.) and the following description relate to various embodiments by way of illustration only. It should be noted that from the following discussion, alternative embodiments of the structures and methods disclosed herein will be readily recognized as viable alternatives that may be employed without departing from the principles discussed herein. Reference will now be made in detail to several embodiments, examples of which are illustrated in the accompanying figures. It is noted that wherever practicable similar or like reference numbers may be used in the figures and may indicate similar or like functionality.

Embodiments relate to communicating over a full duplex control channel of a multimedia communication link by using synchronization indicators that may also function as a logical link command. The synchronization indicators are exchanged between two communicating devices for maintaining synchronization of a logical link. At least two different types of synchronization signals may be sent as synchronization indicators between the two devices. A first synchronization signal is used by default to indicate that the synchronization of the logical link is being maintained. A second synchronization signal is used in place of the first synchronization signal to indicate that the synchronization of the logical link is being maintained. The second synchronization signal also functions as a logical link command to indicate that a device is ready to receive data or has successfully received data over the full duplex channel.

The synchronization described herein refers to an operational status of a logical link defined by a certain protocol as being suitable for transmission of data between two devices. The synchronization may be determined by exchange and verification of synchronization indicators between the two devices.

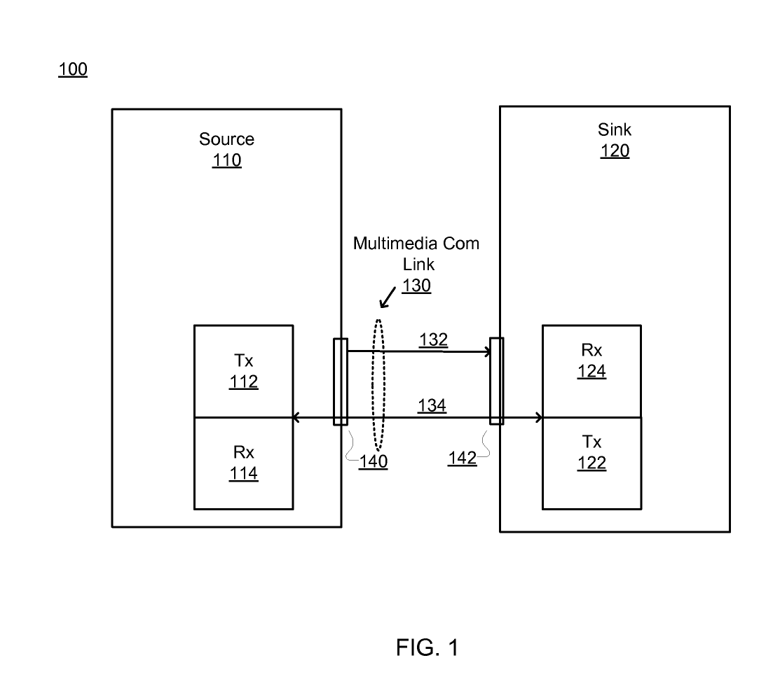

FIG. 1 is a high-level block diagram of a multimedia system 100 for multimedia data communications, according to one embodiment. The multimedia system 100 includes a source device 110 communicating with a sink device 120 through a multimedia communication link 130. The source device 110 is the source of audiovisual data streams. Examples of source device 110 can be mobile phones, digital video disc (DVD) players, blu-ray players, cable boxes, internet protocol television (IPTV) boxes, laptops, or integrated circuits (IC) within such devices. The sink device 120 receives audiovisual data streams, and may include functionality to display the audiovisual data streams received. Examples of the sink device 120 include liquid crystal display (LCD) televisions, LCD monitors, or ICs within such devices.

The multimedia communication link 130 includes an audiovisual channel 132 and a physical control channel 134. The source device 110 is coupled to the audiovisual channel 132 as well as the control channel 134 via the interface 140. The sink device 115 is coupled to the audiovisual channel 132 and the control channel 134 video channel 152 and the control channel 156 via the interface 142. Interfaces 140 and 142 are physical elements through which communications can occur, such as connectors, pins, driving circuits, or receiving circuits, among others.

The source device 110 transmits audiovisual data streams to the sink device 120 across the audiovisual channel 132. The audiovisual channel 132 is one-directional and carries video data streams from the source device 110 to the sink device 120. The audiovisual channel 132 may be implemented using a differential pair of wires. Alternatively, there may be multiple audiovisual channels 132 for transferring one or more video data streams. The audiovisual data stream can be displayed at the sink device 120 or passed on to another device for display.

The source device 110 and the sink device 120 also exchange control data across the control channel 134. The control channel 134 is bi-directional and full duplex such that the source device 110 and sink device 115 can transfer control data with each other at the same time. Control data transmitted over the control channel 134 can include, among others, display data channel (DDC) commands, enhanced display identification data (EDID) data, content protection codes. The control channel 134 may be implemented using a differential pair of wires or a single pair of wires. The control channel 134 may also carry a clock from the source device 110 to the sink device 120.

In one embodiment, the multimedia communication link 130 is a mobile high definition link (MHL) and the control channel 134 is an enhanced control bus (eCBUS) for MHL. However, embodiments of the present disclosure are not restricted to MHL and can include embodiments where the multimedia communication link 130 is a high definition multimedia interface (HDMI) link or other type of multimedia communication link. The control channel 134 may further provide a high-speed, bi-directional path for data transfer between the source device 110 and the sink device 120.

In order to transmit data efficiently, multiple logical links may be multiplexed onto one physical channel and transmitted from the source device 110. For this purpose, the control channel 134 may support multiple communication protocols, where each communication protocol is supported by one logical link. Each communication protocol may specify a different set of rules for communication of a different type of control data. For example, protocols for high-throughput MHL sideband channel (eMSC) and First Generation MHL Link Control Bus (CBUS1), among others, may be supported.

The control channel 134 may allocate its bandwidth using time division multiplexing (TDM). Each logical link is allocated to one or more time slot positions within a TDM frame for transmission across the control channel 134 via the interface 140. TDM frames are received and decoded to extract control data which is forwarded to the appropriate protocol. Multiple independent logical links may be allocated a fixed portion of the control channel 134 bit times, so that each logical link is guaranteed a fixed bandwidth and latency. The bandwidth and latency through the control channel 134 are determined by the assignment of TDM slots and by the mode of the TDM slot.

The control 134 is full-duplex such that the data may be transferred simultaneously in both directions: from the source device 110 to the sink device 120 and from the sink device 120 to the source device 110. Some protocols support bi-directional data flows. During TDM time slots assigned for a protocol that supports bi-directional data flows, the source device 110 and the sink device 120 can transmit and receive data via the control channel 134 simultaneously. In the illustrated example, the source device 110 includes a sending module 112 and a receiving module 114, and the sink device 120 includes a sending module 122 and a receiving module 124. The source device 110 and the sink device 120 may transmit and receive data between each other simultaneously. For example, data sent by the sending module 112 of the source device 110 is received by the receiving module 124 of the sink device 120, and data sent by the sending module 122 of the sink device 120 is received by the receiving module 114 of the source device 110.

Some protocols support block transactions. Block transactions support a more efficient means of data transfer, using a request and grant mechanism at the beginning of the transaction. After a logical link is established, a block transaction begins with the requester (e.g., the source device 110) sending a request command. The requester (e.g., the source device 110) may also send a count value indicating the size of the payload. The sending module (e.g., the sending module 112) of the requester may wait until the receiving module (e.g., the receiving module 114) of the requester receives from a responder (e.g., the sink device 120) that this request is granted. If the sending module times out waiting, the sending module returns to the idle state.

After receiving a logical link command indicating that the responder (e.g., the sink device 120) granted the requester's command, the sending module (e.g., the sending module 112) may send a logical link command to the receiving module (e.g., the receiving module 124) indicating that the data stream has started. The receiving module (e.g., the receiving module 124) of the responder is notified that the payload data follows immediately after the logical link command. The sending module (e.g., the sending module 112) of the requester continues to fill its channel with payload bytes, up to the size indicated to the receiving module (e.g., the receiving module 124) of the responder. The sending module (e.g., the sending module 112) of the requester may send a Cyclic Redundancy Check (CRC) value to the receiving module (e.g., the receiving module 124) of the responder in the next TDM time slots after the last byte of the payload. In one embodiment, a 16-bit CRC is sent to indicate data bytes of a logical link packet, a 2-bit CRC is sent to indicate the logical link packet includes a 1-byte header, and a 3-bit CRC is sent to indicate the logical link packet includes a 2-byte header.

A sending module (e.g., the sending module 112 or 122) may wait till it times out or a receiving module (e.g., the receiving module 114 or 124) receives a logical link command (e.g., acknowledge, negative-acknowledge, or error). When a sending module times out, the requester may re-try for at least a number of times (N_{RETRY}) after a minimum interval (T_{RETRY}). When a sending module receives a virtual link command such as acknowledge, the virtual link transaction completes. When a sending module receives a virtual link command such as negative-acknowledge or error, the sending module may retry the entire virtual link transaction from the beginning at least a number of times (N_{RETRY}) after a minimum interval (T_{RETRY}).

The source device 110 and the sink device 120 may each include a buffer. The sending module 112 and the receiving module 114 of the source device 110 are similar in function to their counterparts (i.e., the sending module 122 and the receiving module 124) in the sink device 120. Thus, the operation of the sending module 112 and the receiving module 114 described herein apply also to the sending module 122 and the receiving module 1241, and therefore, the description on the operation of the sending module 122 and the receiving module 124 is omitted herein for the sake of brevity.

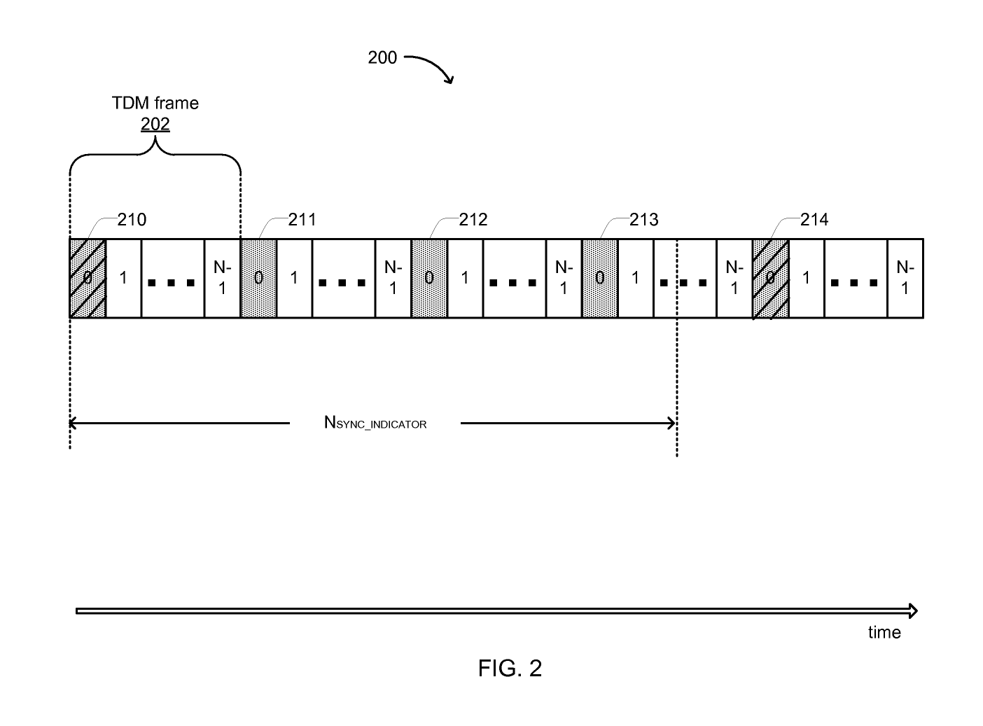

FIG. 2 is a diagram illustrating synchronization characters sent in allocated time-division multiplexed (TDM) time slots to establish or maintain a logical link in the multimedia system of FIG. 1, according to an embodiment. The bandwidth of the control channel 134 is divided into repeating time slots using TDM. In some embodiments, a mechanism to transfer arbitrary data between two devices (e.g., a source device 110 and a sink device 120) is supported by a logical link established over the control channel 134. In one embodiment, the data payload may be any size less than a predetermined number of bytes (e.g., from 1 byte to 256 bytes). The first byte of the data payload may be sent first, followed by the second byte of the data payload sent next, and so on to the last byte of the payload, which is sent last.

The source device 110 and the sink device 120 may use a series of synchronization indicators to maintain the synchronization of the logical link between the source device 110 and the sink device 120. For example, the sending module 112 sends a default signal or a non-default signal as synchronization indicators. Each of the synchronization indicators may be inserted by the sending module 112 or the sending module 122. The receiving module 124 or the receiving module 114 receives the synchronization indicators and takes actions to re-establish the logical link if the synchronization indicators are not received as expected. The series of synchronization indicators may occur anywhere within the logical link data stream, within or outside a logical link command, a logical link packet, or a logical link transaction. A logical link command includes one or two bytes sent by a requester or replied by the responder, as part of a larger exchange. A requester is the device requesting to send a payload and a responder is the device responding to the request. A logical link packet includes a command with data bytes required by that command sent from the sending module of the requester. A logical link transaction includes packets sent and received between a sending module and a receiving module, during an interval that begins at an idle state and ends at an idle state. A logical link transaction is a closely-defined exchange of data between devices.

The control channel 134 may be logically divided into repeating time slots using TDM. The time slots for communications across the control channel 134 may be logically divided into source time slots and sink time slots. Source time slots represent TDM time slots for transmission of data from a source device 110 to a sink device 120 across the control channel 134, and sink time slots represent TDM time slots for transmission of data from a sink device 120 to a source device 110 across the control channel 134. The control channel 134 is a full duplex channel so data can be transferred simultaneously in both directions using source time slots and sink time slots. In the illustrated example of FIG. 2, the time slots 200 may be source time slots or sink time slots. As illustrated, the time slots 200 are also organized into TDM frames, each of which includes N time slots (e.g., time slots 0 to N−1). A TDM frame represents a cycle for transmission of data for N logical links

Within a TDM frame 202, each time slot may be allocated for a logical link. For example, as illustrated, the time slots 210, 211, 212, 213 and 214 in each corresponding TDM frame are allocated to send data of a communication protocol as described above with reference to FIG. 1. Other time slots in a TDM frame may be allocated for different communication protocols (e.g., eCBUS, Remote Button Protocol commands, Tunnel CBUS in MHL protocol).

The synchronization indicators are sent periodically to maintain the synchronization of the logical link or to check for loss of synchronization in or more communication protocols used for sending data over the control channel 134. In the illustrated example of FIG. 2, synchronization indicators for the logical link are sent in the time slots 210 and 214. Synchronization indicators may be sent periodically on a TDM time slot. In some embodiments, a synchronization indicator is sent on the next TDM time slot after a number (N_{SYNC}_{_{—}}_{INDICATOR}) of bytes. For example, in the illustrated example of FIG. 2, a first synchronization indicator is sent in time slot 210 and a second synchronization indicator is sent in time slot 214 which appears after a number (N_{SYNC}_{_{—}}_{INDICATOR}) of bytes. In some embodiments, the number of bytes between two consecutive synchronization indicators is at least a predetermined number of bytes (e.g., 24 bytes). The sending module (e.g., the sending module 112, the sending module 122) of a device may send a default signal or a non-default signal in the TDM slots 210 and 214.

Because a time slot for a logical link may occur at any point of a protocol transaction, a synchronization indicator may occur at any point in a logical link transaction. For example, a synchronization indicator may occur between the bytes of a 2-byte logical link command or in the sequence of bytes in a logical link packet. In some embodiments, a synchronization indicator may occur anywhere in the overall logical link transaction. The receiving module of a device may check for the presence of a synchronization indicator periodically at TDM time slots scheduled for sending synchronization indicators. A sending module may send a default signal as synchronization indicators periodically at TDM time slots.

Instead of sending a default signal as synchronization indicators, a sending module may send a non-default signal different from the default signal as synchronization indicators. Because the TDM time slot for sending a synchronization indicator may occur at any point during the progress of a logical link transaction, a virtual link command may be used in the TDM time slot when the sending module of the device is busy sending a data packet. In one embodiment, the non-default signal is sent when the TDM slot scheduled for the synchronization indicator is in the middle of a data packet. The TDM time slot may occur before an end of the data packet. When sending this non-default signal as a synchronization indicator, the non-default signal may be used to indicate a logical link command such as grant or acknowledge. The logical link command grant is used to grant a request to send a payload. That is, a transfer request is granted. The logical link command acknowledge is used to confirm receipt of a payload. That is, data is received without error. In other words, rather than sending an express logical link command, the non-default signal is sent to imply a logical link command and as a synchronization indicator.

For example, a requester may request to send a payload to another device. The sending module of the requester does not send the payload until the receiving module receives a logical link command (e.g., grant) from the other counterpart device. After the responder determines that it is ready to receive the payload, the sending module of the responder may send a non-default synchronization signal to grant the requester's request to send the payload as well as to confirm synchronization of the logical link. The non-default synchronization signal is sent during the transmission of a data packet. After the receiving module of the requester receives the non-default synchronization signal, the sending module of the requester may continue sending the payload following the protocol of the logical link. After the responder successfully receives the payload transmitted from the requester, the sending module of the responder may send a non-default synchronization signal to indicate acknowledgment of receipt of the payload to the requester receipt as well as maintain the link synchronization. The non-default synchronization signals are used only when a link command is ready to be sent in the middle of a link transaction and the time slot for the synchronization indicator occurs before the end of the link transaction.

In some embodiments, time out may occur when a logical link command (e.g., acknowledge, negative-acknowledge, grant, start of data byte series, or error) is not received within a time frame. The logical link command negative-acknowledge is used to indicate a device cannot receive a payload. That is, data cannot be received because the buffer is full. The logical link command start of data byte series is used to indicate the start of data byte series. A receiving module may time out after waiting for no more than a predetermined time period (T_{RESP}_{_{—}}_{TMOUT}_{_{—}}_{MAX}), and a sending module may time out after waiting for no less than the predetermined time period (T_{RESP}_{_{—}}_{TMOUT}_{_{—}}_{MIN}). Non-default synchronization signals received in the idle state are ignored. The non-default signal received when a logical link command is not due may be treated as an invalid command. When receiving an invalid logical link command within the data transfer part of a logical link transaction, the device may force an error. For example, the sending module of the device may send an inverted CRC at the end of the data stream. When an invalid logical link command is received within at any other time during a logical link transaction, the device may abandon the logical link transaction, which may lead to a timeout at the sending module and the receiving module of the device.

A missing synchronization indicator may indicate a possible loss of synchronization. A logical link may be deemed to have lost synchronization after the number of consecutive synchronization indicator mismatches reaches a threshold. In some embodiments, the threshold is 4 bytes. The logical link that is out of synchronization may return to a synchronization training sequence. The synchronization training sequence is typically carried out shortly after the control channel 134 is connected in order to initialize the logical link. But the synchronization training sequence may also be carried out when the link is determined to have lost synchronization.

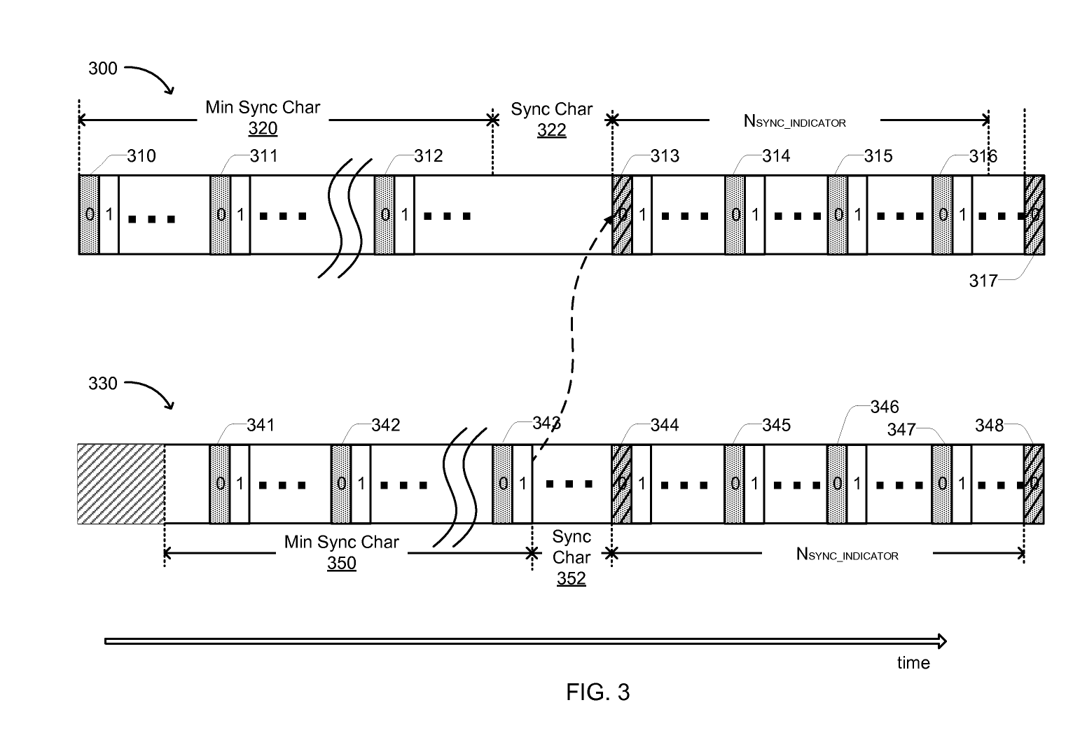

FIG. 3 is a diagram illustrating a synchronization training sequence for a logical link in the multimedia system 100 of FIG. 1, according to an embodiment. A sending module of a device may perform synchronization training upon a logical link initialization or upon a loss of synchronization error condition. A logical link may lose its synchronization when the number of consecutive synchronization indicator mismatches reaches a threshold. A device may perform synchronization training at any time. A sequence of synchronization characters need to be sent until two conditions are satisfied: 1) the sending module has sent at least a number (N_{—}_{^{INIT}}_{—}_{^{SYNC}}) of synchronization characters, and 2) the receiving module has received at least a number (N_{—}_{^{INIT}}_{—}_{^{SYNC}}) of synchronization characters sent from the sending module of the other device. The sending module of the device continues to send synchronization characters till the next time slot scheduled for a synchronization indicator.

For example, as illustrated, the time slots 300 are allocated for the sending module (e.g., the sending module 112) of a first device (e.g., the source device 110) to transmit data across the control channel 134 and the time slots 330 are allocated for the sending module (e.g., the sending module 122) of a second device (e.g., the sink device 120) to transmit data across the control channel 134. Data transmitted over the time slots 330 is received by the receiving module of the first device (e.g., the source device 110).

The synchronization training process starts when the sending module of the first device starts sending synchronization characters. The sending module 112 sends a number (N_{—}_{^{INIT}}_{—}_{^{SYNC}}) of synchronization characters 320 and keeps sending synchronization characters 322 till the receiving module 124 has received at least a number (N_{—}_{^{INIT}}_{—}_{^{SYNC}}) of synchronization characters 350 and the next time slot 313 scheduled to send a synchronous indicator occurs. At the same time, the sending module 122 sends a number (N_{—}_{^{INIT}}_{—}_{^{SYNC}}) of synchronization characters 350 and keeps sending synchronization characters 352 till the receiving module 124 receives at least a number (N_{—}_{^{INIT}}_{—}_{^{SYNC}}) of synchronization characters 320 and the next time slot 344 scheduled to send a synchronous indicator occurs.

Synchronization characters need to be sent periodically and a synchronization indicator is sent on the next TDM time slot after a number (N_{SYNC}_{_{—}}_{INDICATOR}) of bytes are sent for that logical link. In the illustrated example, after both the receiving modules 114 and 124 receive at least a minimum number of synchronization characters, the sending module 112 sends a first synchronization indicator in the TDM time slot 313 and sends a second synchronization indicator in the TDM time slot 317, the next TDM time slot after a number of bytes starting from the TDM time slot 313. The sending module 122 sends a first synchronization indicator in the TDM time slot 344 and sends a second synchronization indicator in the TDM time slot 348, the next TDM time slot after a number of bytes starting from the TDM time slot 344.

Upon reading this disclosure, those of skill in the art will appreciate still additional alternative designs for a multimedia system for data communications over a full duplex control channel of a multimedia communication link. Thus, while particular embodiments and applications of the present disclosure have been illustrated and described, it is to be understood that the embodiments are not limited to the precise construction and components disclosed herein and that various modifications, changes and variations which will be apparent to those skilled in the art may be made in the arrangement, operation and details of the method and apparatus of the present disclosure disclosed herein without departing from the spirit and scope of the disclosure as defined in the appended claims.

What is claimed is:

1. A first apparatus for communicating audiovisual data, the first apparatus comprising:
a receiving module configured to receive a request from a second apparatus to transmit a payload to the first apparatus over a full duplex data link; and
a sending module configured to:
send data to the second apparatus, the data including a series of synchronization indicators for maintaining synchronization of the full duplex data link with the second apparatus over the full duplex data link, and
send a first predetermined signal as one of the series of synchronization indicators to the second apparatus to cause the second apparatus to send the payload to the first apparatus over the full duplex data link, responsive to determining that the first apparatus is ready to receive the payload from the second apparatus.

2. The first apparatus of claim 1, wherein the sending module is configured to send a second predetermined signal as one of the series of synchronization indicators to indicate maintaining of synchronization of the full duplex data link without indicating that the first apparatus is ready to receive the payload from the second apparatus.

3. The first apparatus of claim 1, wherein the sending module is further configured to send the first determined signal as one of the series synchronization indicators to the second apparatus to acknowledge to the second apparatus receipt of the payload by the first apparatus over the full duplex data link, responsive to determining that the first apparatus received the payload from the second apparatus.

4. The first apparatus of claim 1, wherein the series of synchronization indicators is sent periodically in a Time-Division Multiplexing (TDM) time slot.

5. The first apparatus of claim 4, wherein the series of synchronization indicators is sent at least every predetermined number of bytes.

6. The first apparatus of claim 4, wherein the sending module is configured to send the first predetermined signal responsive to determining that the TDM slot is in a middle of a data packet.

7. The first apparatus of claim 1, wherein a size of the payload is configured to be less than a predetermined number of bytes.

8. The first apparatus of claim 1, wherein the sending module is further configured to send at least a predetermined number of synchronization characters to perform synchronization training and the receiving module is further configured to receive at least the predetermined number of synchronization characters transmitted from the second apparatus.

9. The first apparatus of claim 1, wherein the sending module is configured to time out responsive to waiting for no less than a threshold time.

10. A first apparatus (requestor) for audiovisual data communication, the first apparatus comprising:
a receiving module configured to receive data from a second apparatus, the data including a series of synchronization indicators for maintaining synchronization of a full duplex data link with the second apparatus over the full duplex data link; and
a sending module configured to:
send a request to transmit a payload to the second apparatus over the full duplex data link, and
send the payload to the second apparatus over the full duplex data link, responsive to receiving a first predetermined signal in the series of synchronization indicators at the receiving module, the first predetermined signal indicating that the second apparatus is ready to receive the payload.

11. The first apparatus of claim 10, wherein the receiving module is configured to verify the series of synchronization indicators including the first predetermined signal and a second predetermined signal.

12. The first apparatus of claim 10, wherein the receiving module is configured to determine that the full duplex data link is out of synchronization responsive to determining that a number of consecutive mismatch of the series of synchronization indicators received at the receiving module exceeds a threshold.

13. The first apparatus of claim 10, wherein the receiving module is further configured to detect another first predetermined signal in the series of synchronization indicators as an acknowledgement of receipt of the payload sent by the second apparatus over the full duplex data link.

14. The first apparatus of claim 10, wherein the series of synchronization indicators is received periodically in a Time-Division Multiplexing (TDM) slot.

15. The first apparatus of claim 10 is further configured to ignore a synchronization indicator received outside the TDM slot.

16. The first apparatus of claim 14, wherein the series of synchronization indicators is received at least every predetermined number of bytes.

17. The first apparatus of claim 10, wherein a size of the payload is configured to be less than a predetermined number of bytes.

18. The first apparatus of claim 10, wherein the sending module is further configured to send at least a predetermined number of synchronization characters to perform synchronization training of the full duplex data link and the receiving module is further configured to receive at least the predetermined number of synchronization characters transmitted from the second apparatus.

19. The first apparatus of claim 10, wherein the receiving module is configured to time out responsive to waiting for no more than a threshold time.

20. A method for communicating audiovisual data, comprising:
sending, at a first apparatus, first synchronization signals to maintain synchronization of a full duplex data link with a second apparatus over the full duplex data link;
receiving, at the first apparatus, a request from the second apparatus to transmit a payload to the first apparatus over the full duplex data link;
determining whether the first apparatus is ready to receive the payload from the second apparatus responsive to receiving the request; and
sending a second synchronization signal different from the first synchronization signal to the second apparatus to cause the second apparatus to send the payload to the first apparatus and to indicate that data transmission over the full duplex data link is synchronized, responsive to determining that the first apparatus is ready to receive the payload.
